(19) United States
(12) Patent Application Publication
(10) Pub. No.: US 2005/0262053 A1
(43) Pub. Date: Nov. 24, 2005

(54) System and method for storing and accessing information via smart knowledge agents

(75) Inventors: Jeffrey Liou, Hsinchu City (TW); Joseph Du, Hsinchu City (TW); Chun Yi Chen, Hualien County (TW); Yueh-Ching Lee, Taoyuan County (TW)

Correspondence Address: David M. O`Dell;Attorney for Applicants Haynes and Boone,LLP, 901 Main Street suite 3100, Dallas, TX, 75202-3789, US

(73) Assignee: Taiwan Semiconductor Manufacturing Co., Ltd., Hsin-Chu (TW)

(21) Appl. No.: 10/847,746

(22) Filed: May 18, 2004

(51) Int. Cl. G06F 7/00

(52) U.S. Cl. 707/3

(57) ABSTRACT

The present disclosure provides a system and method for storing and accessing information. In one example, the system includes an internal smart agent, an internal knowledge tree connected to the internal smart agent, and an external data source. The internal smart agent is adapted to query the internal knowledge tree prior to accessing the external data source to provide information.

### FIELD OF DISCLOSURE

The present disclosure relates generally to the field of semiconductor manufacturing and, more particularly, to a system and method for conceptual information retrieval and information structuring.

### BACKGROUND

The semiconductor integrated circuit (IC) industry has experienced rapid growth. Technological advances in IC materials and design have produced generations of ICs where each generation has smaller and more complex circuits than the previous generation. However, these advances have increased the complexity of processing and manufacturing ICs and, for these advances to be realized, similar developments in IC processing and manufacturing have been needed. For example, an IC is formed by creating one or more devices (e.g., circuit components) on a substrate using a fabrication process. As the geometry of such devices are reduced, the IC's active device density (i.e., the number of devices per IC area) and functional density (i.e., the number of interconnected devices per IC area) has become limited by the fabrication process.

Furthermore, as the IC industry has matured, the various operations needed to produce an IC may be performed at different locations by a single company and/or by different companies that specialize in a particular aspect of the manufacturing. This further increases the complexity of producing ICs, as companies and their customers may be separated not only geographically, but also by time zones, making effective communication more difficult. For example, a first company (e.g., an IC design house) may design a new IC, a second company (e.g., an IC foundry) may provide the processing facilities used to fabricate the design, and a third company may assemble and test the fabricated IC. A fourth company may handle the overall manufacturing of the IC, including coordination of the design, processing, assembly, and testing operations.

The fabrication of complex semiconductor devices employs many manufacturing steps, when combined the manufacturing may take up to several months. In a semiconductor manufacturing system there is a vast amount of data available associated with advanced semiconductor manufacturing. Specific data may be extracted through search engines coupled to databases wherein specific key words associated with data may be provided and the search engines may provide information embodied with the specific keywords.

There are many database search engines that are generally employed by the general public, and are also used in manufacturing environments. Many of these search engines rely on key word and/or data input matching to retrieve relevant data. In an advanced semiconductor manufacturing environment there exists a myriad problems that have unknown causes, and may require extensive testing in order to find and resolve the problem. For example, such problems may result from process integration and/or particle contamination. Key word searching and/or data matching may not identify the most relevant information in a database relative to these problems.

Accordingly, what is needed in the art is system and method thereof that addresses the above discussed issues.

### BRIEF DESCRIPTION OF THE DRAWINGS

FIG. 1 illustrates a schematic view of one embodiment of a system for extracting information and providing relationships between different information sets constructed according to aspects of the present disclosure.

FIG. 2 illustrates a schematic view of one embodiment of a virtual integrated circuit (IC) fabrication system constructed according to aspects of the present disclosure.

FIG. 3 illustrates a schematic view of another embodiment of the virtual IC fabrication system of FIG. 2.

FIG. 4 illustrates a schematic view of one embodiment of multiple agents and a matrix within the virtual fabrication system of FIG. 2 constructed according to aspects of the preset disclosure.

FIG. 5 illustrates a schematic view of one embodiment of the matrix of FIG. 4 constructed according to aspects of the preset disclosure.

FIGS. 6a-c illustrate flowchart views of one embodiment for storing and retrieving information from the matrix of FIG. 4 constructed according to aspects of the present disclosure.

FIG. 7 illustrates a screen view of one embodiment of an interface by which a user may interact with an information storage and retrieving system constructed according to aspects of the present disclosure.

FIG. 8 illustrates a schematic view of one embodiment of a system for retrieving information constructed according to aspects of the present disclosure.

FIG. 9 illustrates a schematic view of one embodiment of a system for updating a knowledge tree constructed according to aspects of the present disclosure.

### DETAILED DESCRIPTION

The present disclosure relates generally to the field of semiconductor manufacturing and, more particularly, to a system and method for storing and extracting information, and providing relationships between different information sets. It is understood, however, that the following disclosure provides many different embodiments, or examples, for implementing different features of the disclosure. Specific examples of components and arrangements are described below to aid in the understanding of the present disclosure, but are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

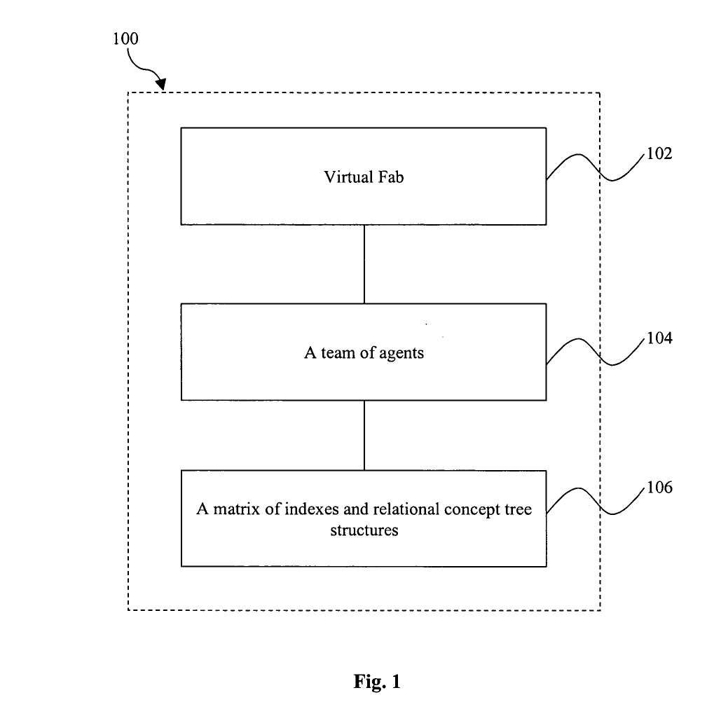

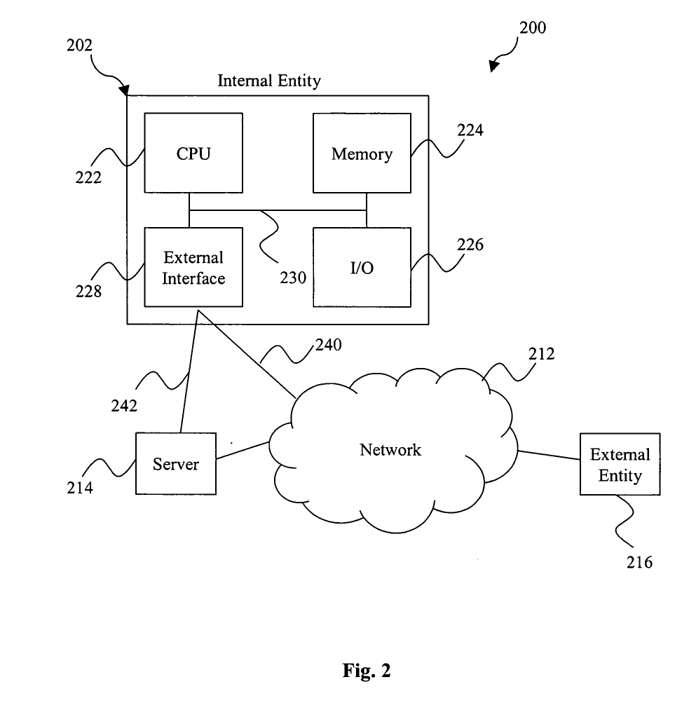

Referring to FIG. 1, a first embodiment of a system for the storage and/or extraction of information and/or providing relationships between different information sets is illustrated. System 100 includes a virtual IC fabrication system 102 (“virtual fab 102”). System 100 also includes a team of agents 104. Team of agents 104 includes a plurality of entities for transporting instructions and retrieving data from a plurality of databases (not shown). Team of agents 104 may include an individual and/or a plurality of hardware devices with software programs that may transverse across a network to different computing entities. Team of agents 104 may also collect information from databases associated with a set of instructions from users. Team of agents 104 may communicate information extracted from a specific data base with each other, and/or may compile retrieved information into a local database of the user. Team of agents 104 may store and/or retrieve data associated with methods and/or systems which may be shared between customers, foundries, assembly facilities, sub-contractors, and/or other entities.

Team of agents 104 may receive instructions and/or retrieve information through virtual fab 102. For example, a user may interact through a computing device with virtual fab 102 and associated team of agents 104 and query a plurality of databases (not shown) with a set of instructions. Team of agents 104 may receive the instructions and/or search for related information within the plurality of databases. Team of agents 104 may build and/or use a user database and/or matrix 106 which may be, for example, a knowledge tree. The matrix 106 may include a plurality of indexes and/or relational databases, and/or concepts may be sorted within matrix 106. The relational databases may include a plurality of information and/or data tree structures wherein the tree structures may be linked to concepts. The concepts may be generated by the cluster of tree structures by statistical methods that are known in the art, by manually sorting data into concepts, or a hybrid approach involving some automatic sorting followed by manual sorting. Concepts may further be assigned by the agents and/or users, and cluster tree structures may be automatically generated by the amendment of information and data through the team of agents. Rules may be provided to the matrix 106 that may define relations between information and/or groups of information.

Matrix 106 may include a plurality of interconnected databases, computational devices, software programs, and interfaces to program agents. The indexes of the matrix may be defined by users, or automatically generated by an association developed by the concept relational database of the matrix. The indexes and the concept relational database may be dynamically and automatically amended by the actions of team of agents 104 where information may be provided by team of agents 104 sequentially, in parallel, or cooperatively to matrix 106.

Referring to FIG. 2, virtual IC fabrication system (“virtual fab”) 200 is one embodiment of application that may be used to implement system 100 of FIG. 1. Virtual fab 200 includes a plurality of entities, represented by one or more internal entities 202 and one and/or more external entities 216 that are connected by communications network 212. Network 212 may be a single network and/or may be a variety of different networks, such as an intranet and the Internet, and may include both wireline and/or wireless communication channels.

Each of entities 202, 216 may include one or more computing devices such as personal computers, personal digital assistants, pagers, cellular telephones, and the like. For example, internal entity 202 is expanded to show central processing unit (CPU) 222, memory unit 224, input/output (I/O) device 226, and external interface 228. External interface 228 may be, for example, a modem, a wireless transceiver, and/or one or more network interface cards (NICs). Components 222-228 are interconnected by bus system 230. It is understood that internal entity 202 may be differently configured and that each of the listed components may actually represent several different components. For example, CPU 222 may actually represent a multi-processor or a distributed processing system; memory unit 224 may include different levels of cache memory, main memory, hard disks, and remote storage locations; and I/O device 226 may include monitors, keyboards, and the like.

Internal entity 202 may be connected to communications network 212 through a wireless and/or wired link 240, and/or through intermediate network 242 and/or server 214, which may be further connected to communications network 212. Intermediate network 242 may be, for example, a complete network or a subnet of a local area network, a company wide intranet, and/or the Internet. Internal entity 202 may be identified on one and/or both of networks 212, 242 by an address and/or a combination of addresses, such as a media control access (MAC) address associated with external interface 228 and an internet protocol (IP) address. Because internal entity 202 may be connected to intermediate network 242, certain components may, at times, be shared with other internal entities. Therefore, a wide range of flexibility is anticipated in the configuration of internal entity 202. Furthermore, it is understood that, in some implementations, server 214 may be provided to support multiple internal entities (not shown). In other implementations, a combination of one and/or more servers and/or computers may together represent a single entity.

In the present example, internal entities 202 represents those entities that are directly responsible for producing the end product, such as a wafer or individually tested IC devices. Examples of internal entities 202 include an engineer, customer service personnel, an automated system process, a design or fabrication facility and fab-related facilities such as raw-materials, shipping, assembly or test. Examples of external entities 216 include a customer, a design provider; and other facilities that are not directly associated or under the control of the fab. In addition, additional fabs and/or virtual fabs may be included with the internal and/or external entities. Each entity may interact with other entities and may provide services to and/or receive services from the other entities.

It is understood that entities 202, 216 may be concentrated at a single location or may be distributed, and that some entities may be incorporated into other entities. In addition, each entity 202, 216 may be associated with system identification information that allows access to information within the system to be controlled based upon authority levels associated with each entities' identification information.

Virtual fab 200 enables interaction among the entities 202, 216 for purposes related to IC manufacturing, as well as the provision of services. In the present example, IC manufacturing may include one or more of the following steps:
receiving or modifying a customer's IC order of price, delivery, and/or quantity;
receiving or modifying an IC design;
receiving or modifying a process flow;
receiving or modifying a circuit design;
receiving or modifying a mask change;
receiving or modifying testing parameters;
receiving or modifying assembly parameters; and
receiving or modifying shipping of the ICs.
receiving or modifying information from a information agent; and
receiving or modifying information within a concept relational database or matrix.

One or more of the services provided by virtual fab 200 may enable collaboration and information access, for example in areas such as design, engineering, and logistics. For example, in the design area, the customer at external entity 216 may be given access to information and tools related to the design of their product via fab 200. The information and tools may enable the customer at external entity 216 to perform yield enhancement analyses, view layout information, and obtain similar information. In the engineering area, the engineer at external entity 216 may collaborate with other engineers (at external entity 216, at internal entity 202, or at other entities) using fabrication information regarding pilot yield runs, risk analysis, quality, and/or reliability. The engineer at external entity 216 may interact with external entity 216 to provide queries to the program agents and to matrix 106 of system 100 of FIG. 1. The logistics area may provide the customer at external entity 216 with fabrication status, testing results, order handling, and/or shipping dates. It is understood that these areas are exemplary, and that more or less information may be made available via virtual fab 200 as desired.

Another service provided by virtual fab 200 may be to integrate systems between facilities, such as between external entity 216 and internal entity 202. Such integration enables facilities to coordinate their activities. For example, integrating external entity 216 and internal entity 202 may enable design information from external entity 216 to be incorporated more efficiently into the fabrication process at internal entity 202, and may enable data from the fabrication process at internal entity 202 to be returned to external entity 216 for evaluation and incorporation into the designs.

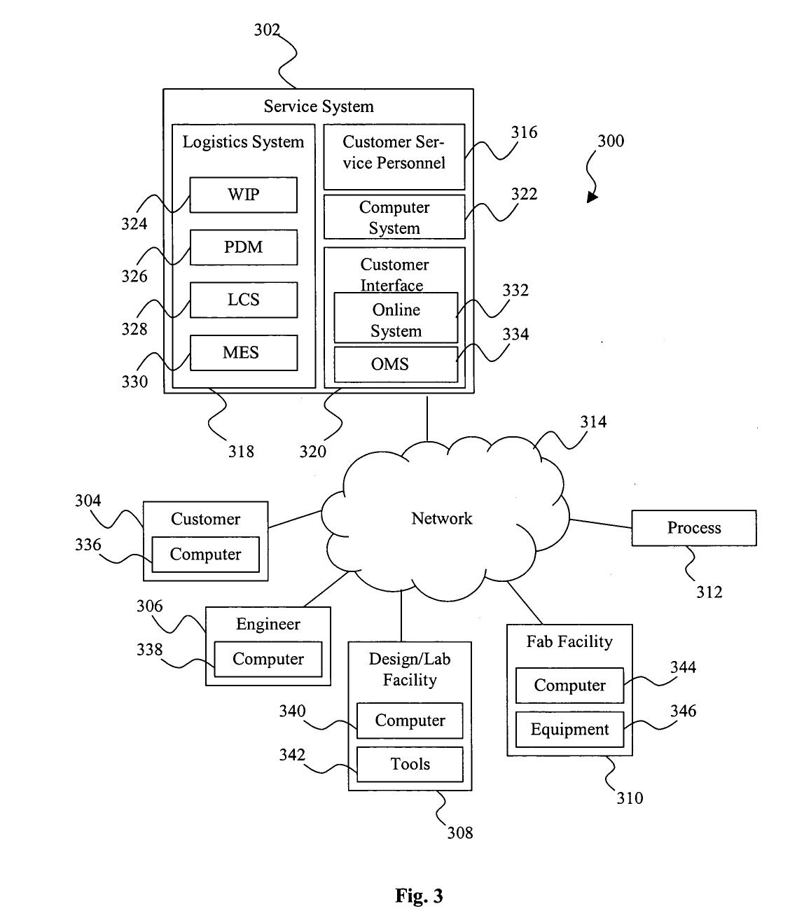

Referring now to FIG. 3, a virtual fab 300 illustrates a more detailed example of the virtuaf fab 200 of FIG. 2. It is understood, however, that the details mentioned and described in FIG. 3 are provided for the sake of example, and that other examples may also be used. Virtual fab 300 includes plurality of entities 302, 304, 306, 308, 310, and 312 that are connected by communications network 314. As illustrated, entity 302 represents a service system, entity 304 represents a customer, entity 306 represents an engineer, entity 308 represents a design/lab facility for IC design and testing, entity 310 represents a fab facility, and entity 312 represents a process (e.g., an automated fabrication process) either inside fab 310, or at another facility. Each entity may interact with other entities and may provide services to and/or receive services from the other entities.

Service system 302 provides an interface between customer 304 and the IC manufacturing operations. For example, service system 302 may include customer service personnel 316, logistics system 318 for order handling and tracking, and customer interface 320 for enabling a customer to directly access various aspects of an order.

Logistics system 318 may include work-in-process (WIP) inventory system 324, product data management system 326, lot control system 328, and manufacturing execution system (MES) 330. WIP inventory system 324 may track working lots using a database (not shown). Product data management system (PDM) 326 may manage product data and maintain a product database (not shown). The product database could include product categories (e.g., part, part numbers, and associated information), as well as a set of process stages that are associated with each category of products. Lot control system (LCS) 328 may convert a process stage to its corresponding process steps.

MES 330 may be an integrated computer system representing the methods and/or tools used to accomplish production. In the present example, the primary functions of MES 330 may include collecting data in real time, organizing and/or storing the data in a centralized database, work order management, workstation management, process management, inventory tracking, and document control. MES 330 may be connected to other systems both within service system 302 and outside of service system 302. Examples of the MES 330 include Promis (Brooks Automation Inc. of Massachusetts), Workstream (Applied Materials, Inc. of California), Poseidon (IBM Corporation of New York), and Mirl-MES (Mechanical Industry Research Laboratories of Taiwan). Each MES may have a different application area. For example, Mirl-MES may be used in applications involving packaging, liquid crystal displays (LCDs), and printed circuit boards (PCBs), while Promis, Workstream, and Poseidon may be used for IC fabrication and thin film transistor LCD (TFT-LCD) applications. MES 330 may include such information as a process step sequence for each product. MES 330 may be interconnected through virtual fab 102 (see FIG. 1) to team of program agents 104 and to matrix 106 where data and/or information may be continuously inputted into matrix 106 through team of agents 104.

Customer interface 320 may include online system 332 and/or order management system 334. Online system 332 may function as an interface to communicate with customer 304, other systems within service system 302, supporting databases (not shown), and other entities 306-312. Order management system (OMS) 334 may manage client orders and may be associated with a supporting database (not shown) to maintain client information and/or associated order information.

Portions of service system 302, such as customer interface 320, may be associated with computer system 322, or may have their own computer systems. In one embodiment, computer system 322 may include multiple computers, some of which may operate as servers to provide services to customer 304 or other entities. Service system 302 may also provide such services as identification validation and access control, both to prevent unauthorized users from accessing data and to ensure that an authorized customer may access only their own data.

Customer 304 may obtain information about the manufacturing of its ICs via virtual fab 300 using computer system 336. In the present example, customer 304 may access the various entities 302, 306-312 of virtual fab 300 through customer interface 320 provided by service system 302. However, in some situations, it may be desirable to enable customer 304 to access other entities without going through customer interface 320. For example, customer 304 may directly access fab facility 310 to obtain fabrication related data.

Engineer 306 may collaborate in the IC manufacturing process with other entities of virtual fab 300 using computer system 338. Virtual fab 300 enables engineer 306 to collaborate with other engineers and/or design/lab facility 308 in IC design and testing, to monitor fabrication processes at fab facility 310, and to obtain information regarding test runs, yields, etc. In one embodiment, engineer 306 may communicate directly with customer 304 via virtual fab 300 to address design issues and other concerns.

Design/lab facility 308 provides IC design and/or testing services that may be accessed by other entities via virtual fab 300. Design/lab facility 308 may include computer system 340 and/or various IC design and testing tools 342. IC design and testing tools 342 may include both software and/or hardware.

Fab facility 310 enables the fabrication of ICs. Control of various aspects of the fabrication process, as well as data collected during the fabrication process, may be accessed via virtual fab 300. Fab facility 310 may include computer system 344 and various fabrication hardware and software tools and equipment 346. For example, fab facility 310 may include an ion implantation tool, a chemical vapor deposition tool, a thermal oxidation tool, a sputtering tool, and/or various optical imaging systems, as well as the software needed to control these tools.

It is noted that when users interact with system 300 they do so by interacting with computer systems coupled to system 300 as describe above. Users include customers, designers, engineers, managers and/or others who desire to interact with the disclosed system to acquire information therefrom. The term “user” is alternatively used to describe not only the person who requests information from the system, but is also used figuratively to describe the computer system or I/O device through which the user interacts with the system.

Process 312 may represent any process and/or operation that occurs within virtual fab 300. For example, process 312 may be an order process that receives and/or fills an IC order from customer 304 via service system 302, a fabrication process that runs within fab facility 310, a design process executed by engineer 306 using design/lab facility 308, and/or a communications protocol that facilities communications between various entities 302-312.

It is understood that entities 302-312 of virtual fab 300, as well as their described interconnections, are for purposes of illustration only. For example, it is envisioned that more or fewer entities, both internal and external, may exist within virtual fab 300, and that some entities may be incorporated into other entities or distributed. For example, service system 302 may be distributed among various entities 306-310. Process 312 may include process equipment and/or other non-equipment related process steps couple to network 314. The time between process 312 steps may be referred to as the queued-time which may include a plurality of values stored in a database. The queued-time related to process 312 steps may be accessed through network 314 and may be analyzed by computer system 336 and/or 338 of customer 304 and/or engineer 306, respectively.

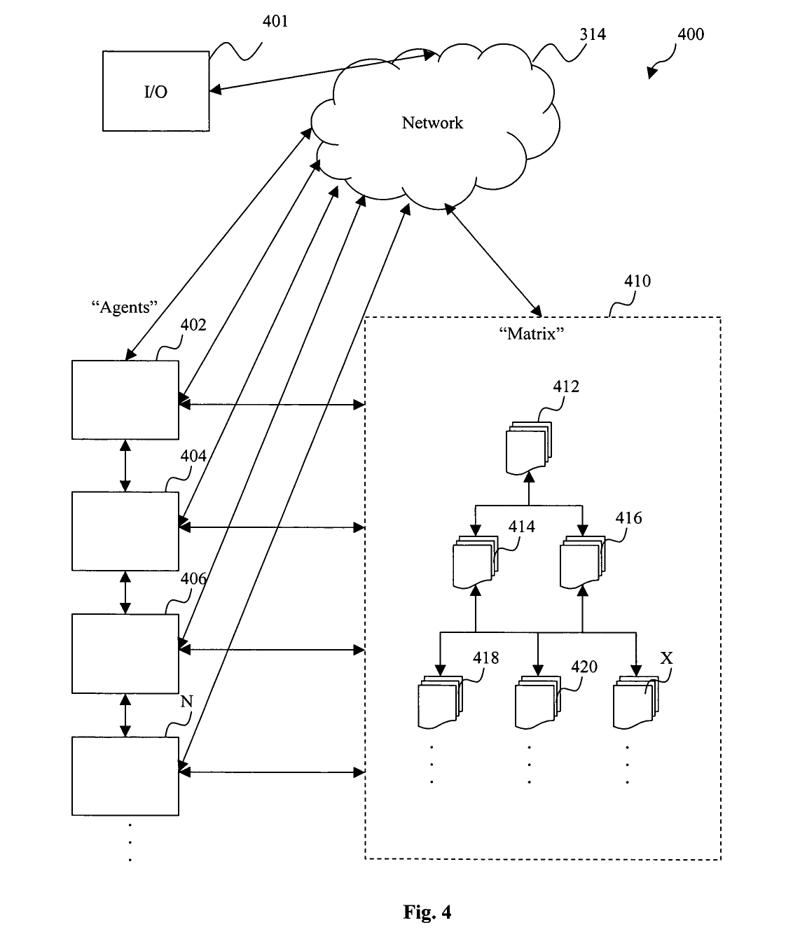

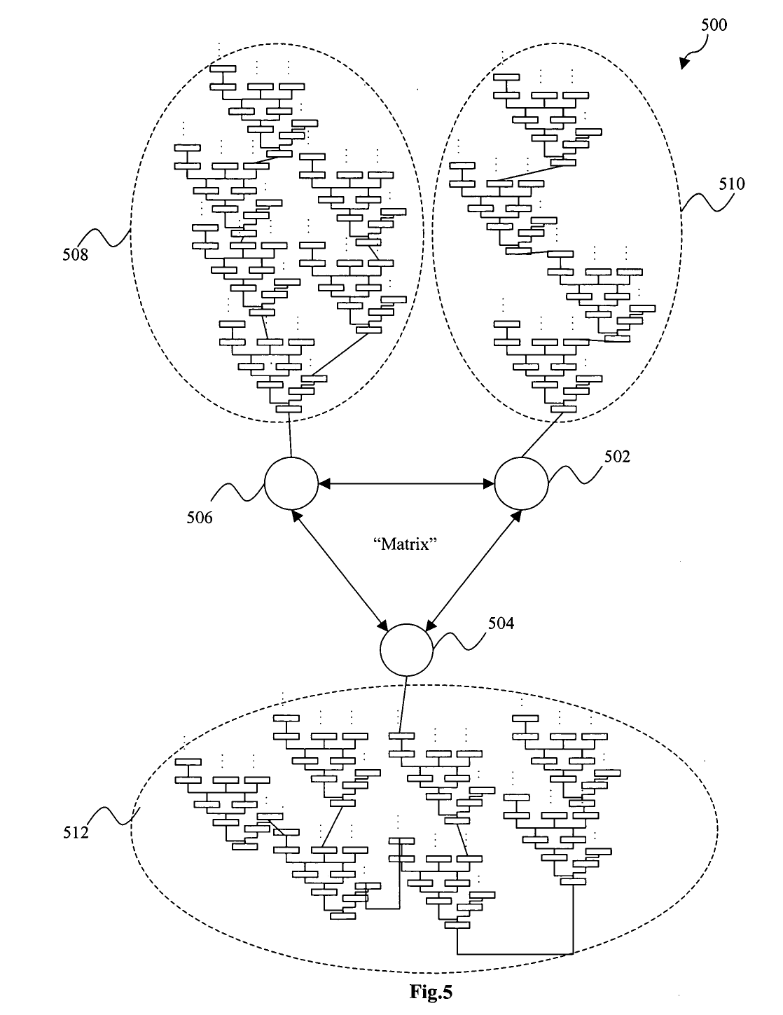

Referring to FIG. 4, in another embodiment, manufacturing system 400 for extracting information and/or providing relationships between different information sets is illustrated. Network 314 of system 400 may be coupled to a plurality of internal entities (not shown) and/or external entities (not shown) for the compilation of conceptual databases associated with information provided in queries from users and/or the team of agents. Entities of system 400 include at least one input/output (I/O) 401, agents 402 through N (402-N) and matrix 410. Matrix 410 may include plurality of indexes 412 through X (412-X) with a plurality of concept tree structures within the indexes 412-X.

I/O 401 may include at least one internal and/or external entity for interacting with agents 402-N and/or matrix 410. I/O 401 may include a plurality of electronic devices and/or other software programs for interacting with agents 402-N and/or matrix 410. I/O 401 may provide search information to agents 402-N.

Agents 402-N may each include a plurality of software programs for extraction of information. Agents 402-N may include search engines based upon key words, statistical patterns, and/or other parameters. Agents 402-N may interact through network 314 and/or any internal and/or external entities (e.g., entities of virtual fab 102, 200, and/or 300). Agents 402-N may process information cooperatively, in parallel, and/or individually. Agents 402-N may be further coupled to matrix 410. Agents 402-N may reside at a variety of locations within system 400, and may be provided instructions from any interface, terminal, PDA, and/or wireless device. Agents 402-N may be created by a user, customer, engineer, and/or other entities with access to virtual fab 102, 200, and 300. Agents 402-N may process instructions and/or information including key words, database queries, automated tasks, process tasks, and/or sequences of events. Agents 402-N may further include hierarchy information wherein a single or plurality of agents 402-N may include higher priorities relative to other agents 402-N. Communication between agents 402-N may occur through virtual fab 102, 200, and/or 300, through network 314, through matrix 410, and/or between agents directly.

Matrix 410 may include a plurality of indexes 412-X. A plurality of concept tree structures may exist within each index 412-X. Agents 402-N may interact with any index 412-X either individually and/or as a cluster, with the interaction occurring sequentially, in parallel, and/or cooperatively. Tree structures within indexes 412-X within matrix 410 may include a plurality of data fields associated with information that may be provided by agents 402-N. Information and/or data provided by agents 402-N may include semiconductor device electrical data, process data, production flow data, and/or any recordable information contained within and/or usable by virtual fab 102, 200, and/or 300.

Matrix 410 may provide grouping by concept relation, wherein concepts may include designated ideas, key words, and/or a cluster of information wherein associated statistical relevance may be computed. Concepts may further be developed in matrix 410 by rules that may be assigned by agents 402-N to indexes 412-X and/or to any component of the tree structures within matrix 410. Information and/or data may be added to matrix 410 by agents 402-N.

Matrix 410 may evolve according to a plurality of queries and/or may allow for data and/or information access in subsequent queries due to the expansion of the concepts and/or knowledge developed through matrix 410. The information may be dynamically grouped according to concepts that may be assigned by agents 402-N and/or by which matrix 410 may determine by statistical relevance optionally combined with the assigned rules. For example, an applied rule may be associated with a specific process such as a metal oxide chemical vapor deposition (MOCVD), atomic layer deposition (ALD), physical vapor deposition (PVD), chemical vapor deposition (CVD), chemical mechanical polishing or chemical mechanical planarization (hereafter collectively referred to as CMP), and/or other process(es), wherein a concept may be assigned to represent an association between film thickness, stoichiometric composition, process cycle-time, product yield, particle counts, and/or end process electrical device characteristics in one embodiment. Other rules may be applied for many different processes, methodologies, and implementations. Rules may further be generated by the statistical agglutination of tree structures based on statistical relevance. Assigned rules may further assist to establish new concepts formulated within matrix 410.

Matrix 410 includes an openly accessible interface by which data and/or information may be added and/or amended within indexes 412-X of matrix 410. Indexes 412-X may include a plurality of concept categories which may be defined by agents 402-N, entities 202 and 216 (see FIG. 2), and/or matrix 410. Matrix 410 may fabricate indexes 412-X by the discovery, cognition, and/or identification of new categories from the information and/or data supplied by agents 402-N and/or from entities 202 and 216 of virtual fab 200.

In operation, a user (not shown) may execute a query through one of the agents 402-N (e.g., the agent 404). For example, if the user is interested in a topic such as “germanium as a substrate,” agent 404 would first access matrix 410 to determine if matrix 410 includes an index associated with the topic “germanium as a substrate,”. If matrix 410 includes an index associated with the topic, the data in the topic may be returned to the user through agent 404. If matrix 410 does not include an index associated with the topic, agent 404 may query one or more external databases for the user's requested topic. Agent 404 presents the data from the external databases to the user, and/or presents the data to matrix 410, Agent 404 may also create new topic N (e.g., “germanium as a substrate”). Future users may then access information on new topic N directly from matrix 410, without having to access external databases.

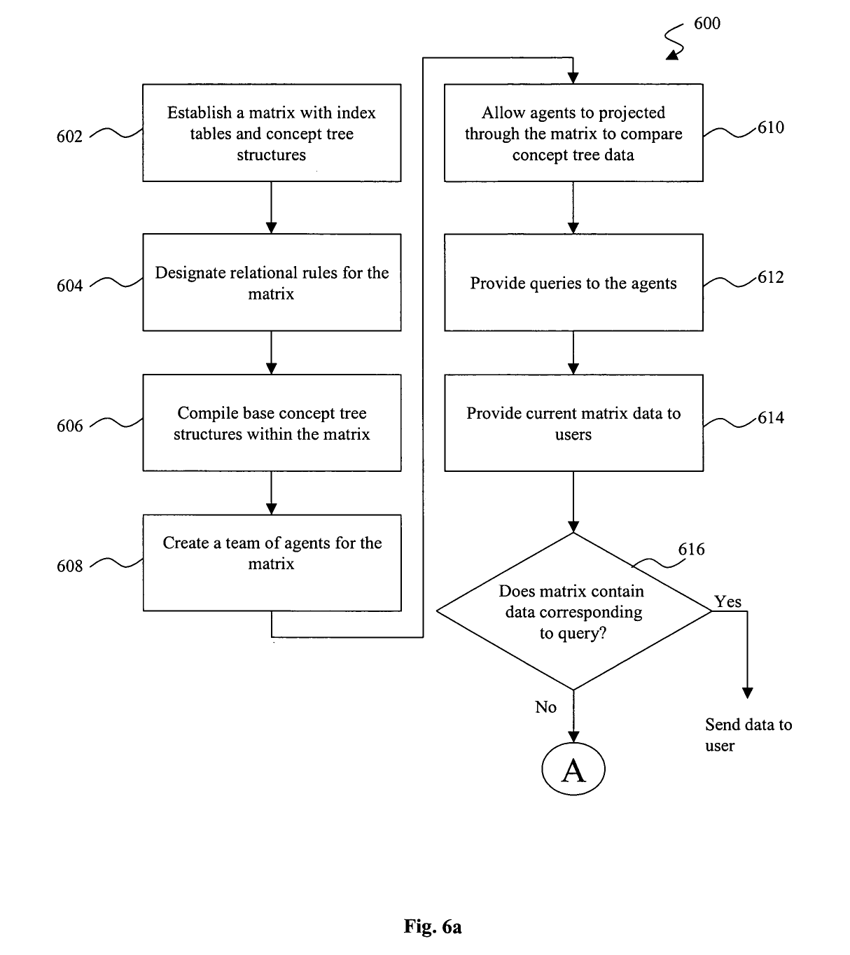

Referring now to FIG. 5, in another embodiment, a diagram 500 of the major components of indexes 412-X of matrix 410 (see FIG. 4) is shown. Diagram 500 illustrates the grouping and/or formation of concepts 502-506. Concepts 502-506 may include statistical data, keywords, and/or other information. Concepts 502-506 may be assigned by agents 402-N, entities 202 and 216 (FIG. 2), and/or matrix 410. Concepts 502-506 may be generated by the agglutination of common information and/or data, where tree structures 508-512 may include a plurality of conceptually and/or statistically related information. Tree structures 508-512 determine inferences of concepts 502-506 and/or may develop concepts 502-506 within matrix 410. Concepts 502-506 may be further interrelated and may be associated with the plurality of indexes 412-X. Concepts 502-506 may be viewed by entities 202 and/or 216. Concepts 502-506 may be automatically changed due to the amendment of old information or the addition of new information and data from agents 402-N, or may be manually changed by authorized internal and external users (e.g., users of the entities 202 and/or 216).

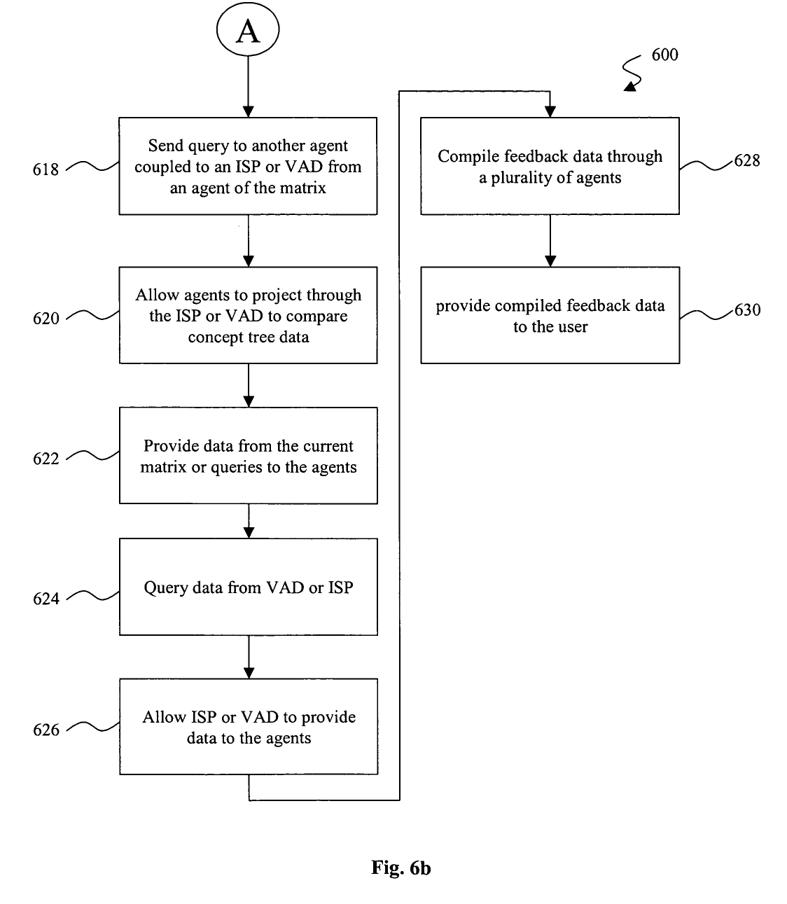

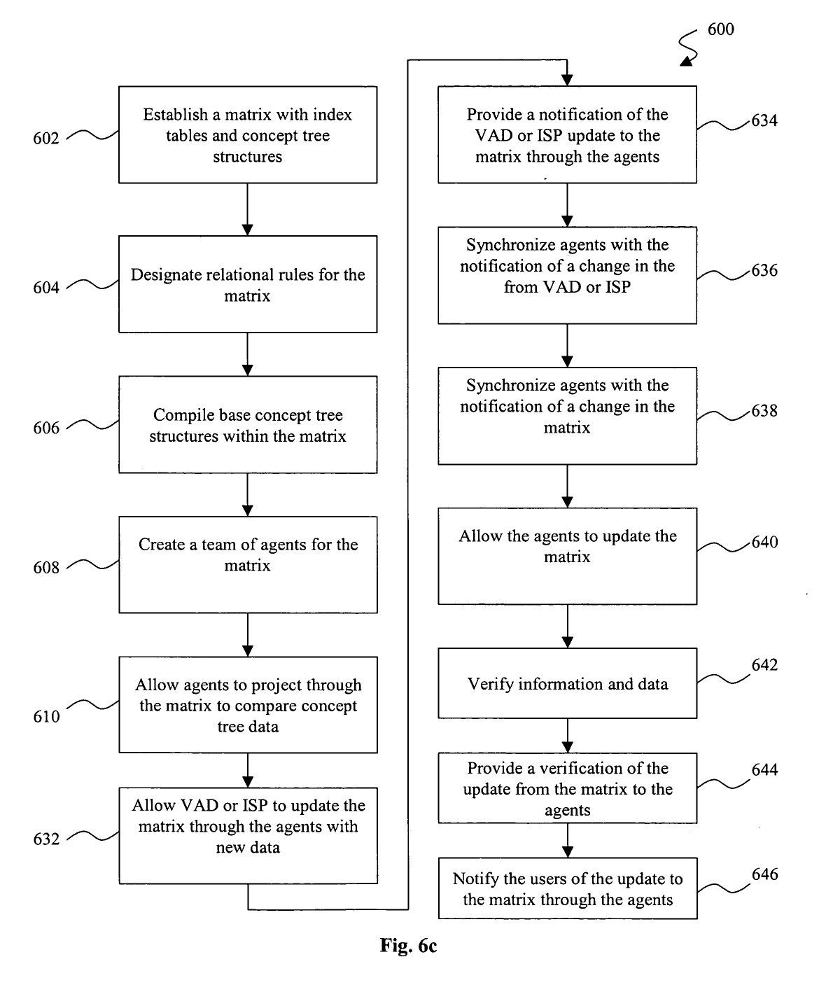

Referring now to the flowcharts of FIGS. 6a-c, in another embodiment, a method 600 may be executed within the system 100 of FIG. 1 is illustrated. Method 600 provides for information delivery from matrix 410 and/or agents 402-N (see FIG. 4), as well as the updating and synching of entities 202, 216 of virtual fab 200 (see FIG. 2) with matrix 410 and/or agents 402-N.

Method 600 begins at step 602 wherein matrix 410, indexes 412-X, concepts 502-506, and tree structures 508-512 may be established within virtual fab 200, 300. Step 604 may provide for the designation of relational and/or exception rules for matrix 410 wherein the rules may be assigned by users and/or entities 202 and 216 of virtual fab 200, 300. The rules may include designation of concepts associated with processes, electrical parameters, and/or any other information of which may be assimilated by matrix 410. The fabrication of base rules may allow for compiling a plurality of base tree structures composed of information and/or data by step 606. The base tree structures may include a plurality of fundamental concepts and/or global attributes.

At step 608, team of agents 402-N may be created to interface with matrix 410 and/or entities 202 and 216. Team of agents 402-N may be hardware and/or software programs that may collect and/or transport information, and may receive instructions from users and/or entities 202 and 216. Agents 402-N may supply matrix 410 with the information and/or data wherein the tree structures evolve in breadth according to the provided information and/or data. Data and/or information may be continuously updated to matrix 410 by agents 402-N wherein information and data may be supplied by a variety of sources. The sources may include databases within virtual fab 102, 200, and/or 300 such as a variety of information system located in a semiconductor manufacturing system and/or externally within a customer's database. Alternatively, sources may include databases and/or search engines within the internet such as information service providers (ISP) and/or value added databases (VAD) such as LEXIS-NEXIS™ (http://www.lexis.com/), GOOGLE™ (http://www.google.com/), or any other internet or intranet based search engine database, website, and/or web server. Agents 402-N at step 610 may be projected through matrix 410 to provide comparison analysis between concept tree data and/or structures. Agents 402-N may compare information and/or data structures within a plurality of databases and/or search engines of virtual fab 102, 200, and 300.

At any instant, the entities 202 and 216 may provide queries to agents 402-N either cooperatively, in parallel, and/or sequentially at step 612. Queries may further be provided by agents 402-N wherein the rules coupled with the evolution of matrix 410 may evolve and/or may trigger exception rules as set forth by entities 202 and 216 at step 604. The exception rules may include rules for providing a specific set of data and/or information which may be absent at a specific time associated with a specific concept 502-506. Alternatively, exception rules may be associated with concepts 502-506 providing a statistically significant concept determined within matrix 410.

At step 614, agents 402-N may provide statistically relevant matrix 410 data and/or information to entities 202 and/or 216 through virtual fab 102, 200, and 300. Statistically relevant matrix 410 data may include significant concepts 502-506 determined by matrix 410 through association of tree structures 508-512 with concepts 502-506.

At step 616, a query by entities 202 and 216 through agents 402-N may determine that there may be no corresponding and/or cognate data and/or information fabricated by matrix 410. The presence of cognate information in matrix 410 may result in the issuance of a notification to the user and/or entities 202 and 216 of the information. However, if an absence of corresponding cognate information and/or data is present, then the processing of the query may be continued by matrix 410 and/or agents 402-N.

At step 618, the query may be sent out to other agents 402-N coupled to other ISP and/or VAD through agents 402-N to matrix 410.

At step 620, agents 402-N may be projected through the ISP, VAD, and/or entities 202, 216 of virtual fab 102, 200, and 300 to compare concept tree structure 508-512 data of matrix 410. Information and/or data may be collected from the ISP and VAD to be incorporated into tree structures 508-512 of concepts 502-506 of matrix 410. As matrix 410 grows, new indexes 412-X may be created and/or related to each other by matrix 410 through statistical significance testing, and/or other means known in the art.

At step 622, agents 402-N may be provided with data and information from matrix 410, and/or queries that aid in a comparison within tree structure 508-512 of matrix 410 with respect to the information and/or data from the ISP, VAD, and/or entities 202, 216 of virtual fab 102, 200, 300.

Once data and/or information corresponding to concepts 502-506 and/or tree structures 508-512 of matrix 410 are received at step 624, the query data and/or information may be sent via agents 402-N to associated tree structures 508-512 of matrix 410, at step 626. Agents 402-N may access matrix 410 after the injection of the relevant data and/or information into matrix 410, wherein cognate data and/or information may be compiled through concepts 502-506 and/or tree structures 508-512.

The data as compiled in matrix 410, by step 628, may be fed back to agents 402-N wherein the compiled data and information may be received by the user(s) and entities 202 and 216 of virtual fab 102, 200, 300 in step 630.

As illustrated in FIG. 6C, in another embodiment, the method 600 may further include steps for synching agents 402-N, matrix 410, and entities 202 and 216 of virtual fab 102, 200, and/or 300. The method 600 of FIG. 6C may include steps 602 through 610 in common with FIG. 1A. Step 632 through step 646 illustrate a methodology for synching one embodiment of system 100. Synching may include notifications to other entities associated with the initiation and/or completion of an action and/or the notification of a change to system 100.

Synching method 600 may begin at step 602 wherein matrix 410, indexes 412-X, concepts 502-506, and/or tree structures 508-512 may be established within virtual fab 102, 200, and/or 300.

Step 604 may provide for the designation of relational rules for matrix 410 wherein the rules may be assigned by entities 202 and/or 216 of virtual fab 102, 200, and/or 300. The rules may include designation of concepts associated with processes, electrical parameters, and/or a variety of other information which may be assimilated by matrix 410.

The fabrication of base rules may allow for a plurality of base tree structures 508-512 comprised of information and/or data, at step 606. The base tree structures 508-512 may include a plurality of fundamental concepts, and global attributes.

At step 608, team of agents 402-N may be created, which may be adapted for interfacing between matrix 410 and entities 202 and/or 216. Team of agents 402-N may include hardware and/or software programs that may collect and/or transport information, and/or may receive instructions from entities 202 and/or 216. Agents 402-N may supply matrix 410 with the information and/or data while tree structures 508-512 evolve in breadth according to the provided information and/or data. Data and/or information may be provided to matrix 410 by agents 402-N from a variety of sources. The sources may include databases within virtual fab 102, 200, and 300 such as a myriad of internal information system(s) located in a semiconductor manufacturing system and/or external information from, for example, a customer's database. Alternatively, sources may include databases, search engines, websites, and/or web servers accessible by the internet such as information service providers ISP, VAD, and other internet and/or intranet based search engine(s) and/or database(s).

Agents 402-N at step 610 may be projected through matrix 410 to provide comparison analysis between concept tree data and/or structures. Agents 402-N may compare information and/or data structures within a plurality of databases and/or search engines regarding virtual fab 102, 200, and 300.

At step 632, the VAD, ISP, and/or entities 202 and 216 may update information or synch with matrix 410 through agents 402-N with new or updated information.

At step 634 the VAD, ISP, and/or entities 202 and 216 may provide a notification of any change and/or perturbation to matrix 410 through agents 402-N.

The notification from the VAD, ISP, and/or other entities 202 and 216 may be passed along and/or synced to other agents 402-N at step 636.

At step 638, matrix 410 may be synced with agents 402-N in regards to a notification of change and/or the notification of change within matrix 410 created by the change in information, data, and cognate information and/or data.

Step 640, allows agents 402-N to interact with matrix 410 to sync information retrieved from the VAD, ISP, and/or entities 202 and 216 of virtual fab 102, 200, and/or 300, and/or query information from users and/or other entities 202 and 216 of the virtual fab 102, 200, and/or 300.

Information and/or data may be verified by agents 402-N and/or matrix 410 in step 642 which may include the transfer of verification notices of receipt.

At step 644, verification may be provided from matrix 410 to agents 402-N.

At step 646, users and entities 202 and 216 which initiate a query to the agents 402-N may be synched with verifications and notifications through agents 402-N. In one embodiment, updating of matrix 410 is provided automatically by matrix 410 and/or agents 402-N upon the receipt of new or updated information from agents 402-N. In another embodiment, updating of matrix 410 may be provided manually by users and/or entities 202 and 216, wherein new and/or updated information from agents 402-N may be received. Users and/or entities 202 and 216 may either accept and/or decline the new and/or updated information, prior to the new and/or updated information being provided to matrix 410.

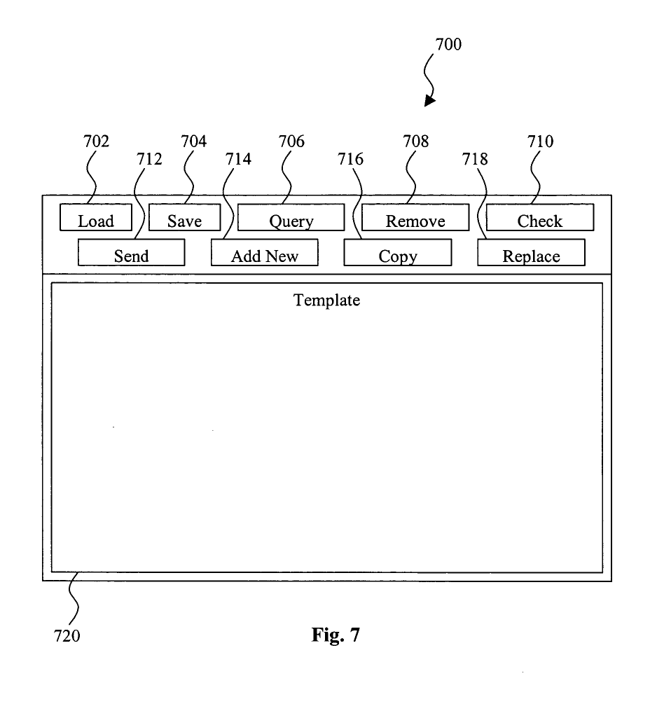

Referring now to FIG. 7, interface 700 illustrates one embodiment of an interface by which internal entities 202 and external entities 216 may interact with system 100 of FIG. 1. It is understood that a variety of interfaces may be presented to system 100 of FIG. 1. As illustrated, interface 700 includes Load button 702, Save button 704, Query button 706, Remove button 708, Check button 710, Send button 712, Add New button 714, Copy button 716, and Replace button 718. Interface 700 may also include template 720 that provides entities 202 and 216 with information regarding agent's (402-N) query results, status of queries, and real-time status of matrix 410 with the tracking of the development of concepts 502-506 and tree structures 508-512. Template 720 may be updated by agents 402-N or any entity 202 and 216 of virtual fab 102, 200, and/or 300. Alternatively, system 100 may be applied to template 720 wherein the functions, queries, and status of agents 402-N and matrix 410 may be visualized and amended. Template 720 may further represent a browser screen, a plurality of selection screens, and a real-time tracking/control and/or selection screens through which agents 402-N and matrix 410 of system 100 may be manipulated.

Load and Save buttons 702, 704 provide the user(s), agents 410-N, or any other entity 202 and 216 with the option to load data and information extracted from system 100 through virtual fab 300. Query button 706 may initiate the query by sending a plurality of instructions to agents 402-N. Remove button 708 enables the user or entities 202 and 216 to remove information from system 100. Check button 710 enables the user or entities 202 and 216 to execute verification methods to check the status of agents 402-N and matrix 410. Send button 712 enables the user or entities 202 and 216 to send data and information to other entities 202 and 216 through virtual fab 102, 200, and/or 300.

Send button 714 may be used to send email notifications to team of agents component 104. Copy button 716 may enable users or entities 202 and 216 to duplicate data and information from a plurality of databases within network 314 (e.g., query instructions, query results, concept information, etc.). Replace button 718 may enable a selected component of information to be replaced by another component of information.

It is to be understood that the buttons and functions are illustrative, and that many other buttons and functions may be provided in other embodiments. For example, a context sensitive menu may be activated by clicking on a mouse button (not shown) or by using a keyboard (not shown). Accordingly, interface 700 may be altered as desired to extend its functionality and support to user(s) and entities 202 and 216.

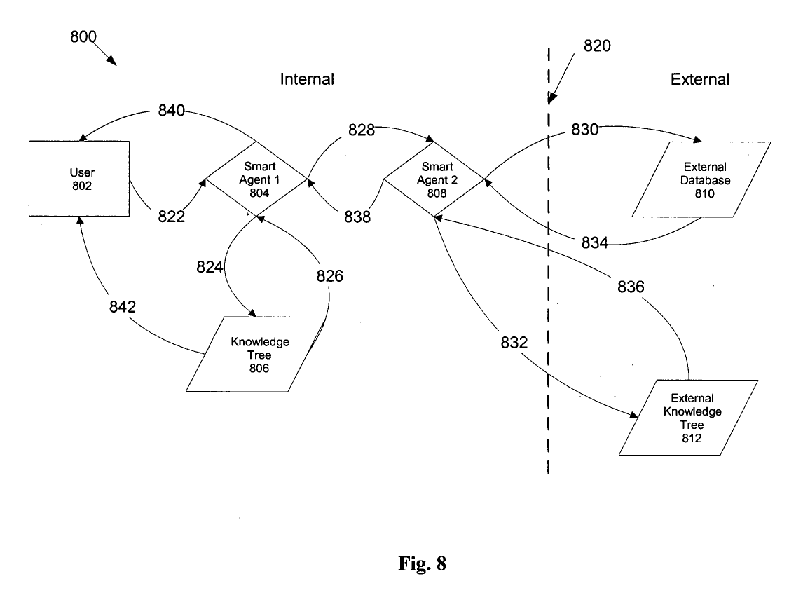

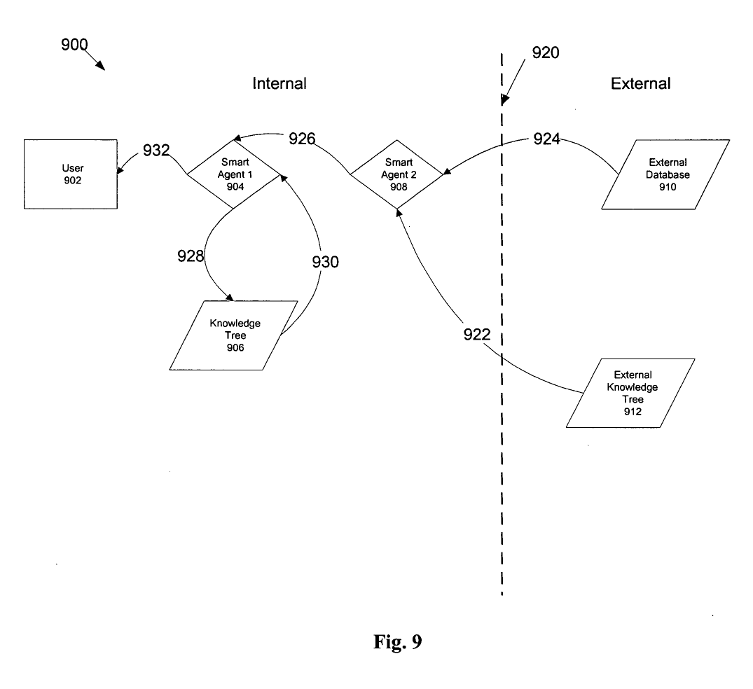

Referring now to FIG. 8, in another embodiment, data management system 800 is illustrated. System 800 includes user 802, smart agent 1 804, knowledge tree 806, smart agent 2 808, external database 810, and external knowledge tree 812. Dashed line 820 is shown dividing internal parts (802, 804, 806, and 808) from external parts (810 and 812). As illustrated, user 802 is internal to data management system 800, while in another embodiment, user 802 is external. In FIGS. 8 and 9 the term “user” not only refers to the person requesting information from the system, but also refers to a computer system or I/O device or I/O port through which queries, responses and other information may be sent and received from the system.

In operation, user 802 may be interested in learning a piece of information or accessing a piece of data, such as data involving what dopants to use with silicon. User 802 sends a query to a smart agent 1 804, shown by arrow 822. Smart agent 1 compares the query with knowledge tree 806 to see if the requested data or information is accessible from internal knowledge tree 806, as shown by arrow 824. Knowledge tree 806 sends the requested data and information to smart agent 1 804, as shown by arrow 826, if the data and information is present.

If sufficient information was retrieved by smart agent 1 804, the process may be finished, and smart agent 1 804 sends the results to user 802, as shown by arrow 840. Alternatively, data and/or information may be sent directly from knowledge tree 806 to user 802, as shown by arrow 842.

If sufficient information was not retrieved by smart agent 1 804, then smart agent 1 804 may send a query to smart agent 2 808, as shown by arrow 828. Smart agent 2 808 may then request the information and/or data from external database 810 and/or external knowledge tree 812, as shown by arrows 830 and 832. Suitable external databases and external knowledge trees include LEXIS-NEXIS (http://www.lexis.com), GOOGLE (http://www.google.com/), YAHOO (http://www.yahoo.com/), United States Patent and Trademark Office databases (http://www.uspto.gov), academic and professional journals, European Patent Office databases (http:H/ep.espacenet.com/), World Intellectual Property Organization databases (http://www.wipo.org/), and/or other private and/or public web sites, web servers, and/or databases.

External database 810 sends the results to smart agent 2 808, as shown by arrow 834. External knowledge tree 812 sends the results to smart agent 2 808, as shown by arrow 836. Smart agent 2 compiles the results from external database 810 and external knowledge tree 812, and provides the results to smart agent 1 804, as shown by arrow 838. Smart agent 1 804 passes the results to user 802, as shown by arrow 840. As illustrated, smart agent 1 804 and smart agent 2 808 are two different parts of system 800. In another embodiment, the functions of smart agent 1 804 and smart agent 2 808 may be performed by a single smart agent.

Referring now to FIG. 9, in another embodiment, a system 900 for updating a knowledge tree is illustrated. System 900 includes user 902, smart agent 1 904, knowledge tree 906, smart agent 2 908, external database 910, and external knowledge tree 912. Dashed line 920 is shown separating internal from external components. User 902 is illustrated as an internal component. In another embodiment, user 902 is external to system 900.

In operation, external database 910 and/or external knowledge tree 912 are updated with a new piece of data and/or information. These updates are fed to smart agent 2 908 as illustrated by arrows 922 and 924. Smart agent 2 908 sends the relevant updates (e.g., those of interest to user 902), to smart agent 1 904, as shown by arrow 926. Smart agent 1 904 provides the updates to knowledge tree 906, as shown by arrow 928, so that topics within the knowledge tree may be changed and/or created according to the updates. The new and changed topics are sent back to smart agent 1 904, as shown by arrow 930, and then sent to user 902, as shown by arrow 932.

As illustrated, knowledge tree 906 is automatically updated by smart agent 1 904 according to external updates. In another embodiment, user 902 receives proposed changes to knowledge tree 906 from smart agent 1 904, and user 902 may either accept or decline the proposed changes. In this way, user 902 is able to filter erroneous information.

Thus, the present disclosure introduces a system for storing and accessing information. In one embodiment, the system may include a first internal smart agent, an internal knowledge tree connected to the internal smart agent, and an external data source including at least one of an external database and an external knowledge tree. The system may also include an internal smart agent that may be adapted to query the internal knowledge tree prior to accessing the external data source to provide information.

In one embodiment, the disclosed system for storing and accessing information includes an internal smart agent, an internal knowledge tree connected to the internal smart agent. An external data source selected from the group consisting of an external database, and an external knowledge tree. The internal smart agent may be adapted to query the internal knowledge tree prior to accessing the external data source to provide information. The system may also include an internal user connected to the internal smart agent. The system may also include an authorized external user connected to the internal smart agent. The system may further be installed within a semiconductor manufacturing system.

In another embodiment, the present disclosure provides a method of accessing requested information including querying an internal knowledge tree for the requested information. The method may also querying an external knowledge source for a remainder of the requested information not received from the internal knowledge tree. The method may also include updating the internal knowledge tree with the information received from the external knowledge source. The method may also include the compiling of the requested information received from the internal knowledge tree and the external knowledge source into a bundle. The method further include providing the bundle to a user, wherein the user may include an internal user. Alternatively, the user may include an external user.

In one embodiment, the present disclosure provides a method of updating an internal knowledge tree including receiving a piece of data from an external source. The method may also provide for the determination if the piece of data is relevant to the internal knowledge tree, and updating the internal knowledge tree with the piece of data. The method may further include providing a notification of the updating of the internal knowledge tree to a user. In one embodiment, the method also includes allowing the user to determine whether or not to update the internal knowledge tree with the piece of data.

In another embodiment, the present disclosure includes a system for extracting information and providing relationships between different information sets in a semiconductor manufacturing environment. The system may include a first group of instructions for establishing a virtual fab having a plurality of entities, a second group of instructions for establishing a team of agents, and a third group of instructions for establishing a matrix. The system may provide for the matrix to be intermixed with a plurality of internal and external entities of the virtual fab, and interfaced by the team of agents, and one or more memories for storing the first, second, or third group of instructions. The system may further include one or more processors for interfacing with the one or more memories and executing the first, second, and third groups of instructions.

Another embodiment of a method for storing and accessing information. Such an embodiment may include a method which includes providing a first internal smart agent. The method may also provide for the maintenance of an internal knowledge tree connected to the internal smart agent. The method may also supply an external data source including at least one of an external database and an external knowledge tree. The method may further provide an internal smart agent adapted for enabling a query to the internal knowledge tree prior to accessing the external data source to provide information.

Another embodiment of a method of updating an internal knowledge tree may include the steps of receiving a piece of data from an external source, then determining if the piece of data is relevant to the internal knowledge tree, and then updating the internal knowledge tree with the relevant pieces of data. The method may further include providing a notification of the updating of the internal knowledge tree to a user.

The present disclosure also provides a system for extracting information and providing relationships between different information sets in a semiconductor manufacturing environment. The system may include a first group of instructions for establishing a virtual fab having a plurality of entities. The entities may also include a second group of instructions for establishing a team of agents, and a third group of instructions for establishing a matrix. The matrix may be intermixed with a plurality of internal and external entities of the virtual fab, and interfaced by the team of agents, and one or more memories for storing the first, second, or third group of instructions.

The present disclosure has been described relative to several embodiments. Improvements or modifications that become apparent to persons of ordinary skill in the art only after reading this disclosure are deemed within the spirit and scope of the application. It is understood that several modifications, changes and substitutions are intended in the foregoing disclosure and in some instances some features of the disclosure will be employed without a corresponding use of other features. Accordingly, it is appropriate that the appended claims be construed broadly, and not limited in any manner by the scope of the disclosure.

1. A system for storing and accessing information comprising:
a first internal smart agent;
an internal knowledge tree connected to the internal smart agent; and
an external data source including at least one of an external database and an external knowledge tree, the internal smart agent being adapted to query the internal knowledge tree prior to accessing the external data source to provide information.

2. The system of claim 1 further comprising a second internal smart agent, coupled to the first internal smart agent, for querying the external data source for information, the first internal smart agent handling queries to the internal knowledge tree for information.

3. The system of claim 1, further comprising an internal user I/O device connected to the first internal smart agent to enable a user to send and receive information.

4. The system of claim 1, further comprising an authorized external user I/O device connected to the first internal smart agent to enable an external user to send and receive information.

5. The system of claim 1 wherein the first internal smart agent and the internal knowledge tree are installed in a semiconductor manufacturing system.

6. The system of claim 1 wherein the first internal smart agent and the internal knowledge tree exist within at least one external entity associated with the internet.

7. The system of claim 1 wherein the first internal smart agent and the internal knowledge tree exist within at least one internal entity associated with a network.

8. A method for storing and accessing information, comprising:
providing a first internal smart agent;
maintaining an internal knowledge tree connected to the internal smart agent; and
supplying an external data source including at least one of an external database and an external knowledge tree, the internal smart agent being adapted to query the internal knowledge tree prior to accessing the external data source to provide information.

9. The method of claim 8, further comprising:
providing a second internal smart agent, coupled to the first internal smart agent, for querying the external data source for information, the first internal smart agent handling queries to the internal knowledge tree for information.

10. The method of claim 8, further comprising:
establishing an internal user I/O device connected to the first internal smart agent to enable a user to send and receive information.

11. The method of claim 8, further comprising an authorized external user I/O device connected to the first internal smart agent to enable an external user to send and receive information.

12. The method of claim 8, further comprising updating the internal knowledge tree with the information received from the external knowledge source.

13. The method of claim 8, further comprising compiling the requested information received from the internal knowledge tree and the external knowledge source into a bundle.

14. The method of claim 13, further comprising providing the bundle to a user.

15. A method of updating an internal knowledge tree, comprising:
receiving a piece of data from an external source;
determining if the piece of data is relevant to the internal knowledge tree;
updating the internal knowledge tree with the relevant piece of data; and
providing a notification of the updating of the internal knowledge tree to a user.

16. The method of claim 15, further comprising allowing the user to determine whether or not to update the internal knowledge tree with the piece of data.

17. A system for extracting information and providing relationships between different information sets in a semiconductor manufacturing environment, the system comprising:
a first group of instructions for establishing a virtual fab having a plurality of entities;
a second group of instructions for establishing a team of agents;
a third group of instructions for establishing a matrix, the matrix intermixed with a plurality of internal and external entities of the virtual fab, and interfaced by the team of agents, and one or more memories for storing the first, second, or third group of instructions.

18. The system of claim 17, further comprising one or more processors for interfacing with the one or more memories and executing the first, second, and third groups of instructions.
